(19) United States
(12) Patent Application Publication
(10) Pub. No.: US 2014/0357098 A1
(43) Pub. Date: Dec. 4, 2014

(54) ELECTRICAL CONNECTOR AND ELECTRICAL CONNECTOR ASSEMBLY THEREOF

(71) Applicant: ALLTOP ELECTRONICS (SUZHOU), LTD., Taicang (CN)

(72) Inventors: Wang-I YU, Jhonghe-City (TW); Shi-Ke XIE, Taicang City (CN); Kuo-Cheng LIU, Jhonghe-City (TW)

(73) Assignee: ALLTOP ELECTRONICS (SUZHOU), LTD., Taicang (CN)

(21) Appl. No.: 14/015,507

(22) Filed: Aug. 30, 2013

(30) Foreign Application Priority Data
Jun. 3, 2013 (CN) 201310216920.2

(51) Int. Cl. H01R 12/72

(52) U.S. Cl. CPC H01R 12/722
USPC 439/59

(57) ABSTRACT

An electrical connector assembly includes an insulative housing, a number of contacts, a least a first PCB electrically connecting with the contacts, a pair of restriction sections, and a pair of fastening elements. The insulative housing comprises an upper wall, a lower wall opposite to the upper wall, and a pair of sidewalls connecting with the upper and lower walls. The contacts are received in the insulative housing. The first PCB comprises a pair of side sections partially surrounding the insulative housing. The pair of restriction sections is connected with the sidewalls of the insulative housing and partially overlaps with side sections of the first PCB. The pair of fastening elements respectively passes through the restriction sections and the side sections of the first PCB to align and position the relative position between the insulative housing and the first PCB for achieving more reliably electrical connection between the first PCB and the contacts.

### BACKGROUND OF THE INVENTION

1. Field of the Invention

The present invention relates to an electrical connector, more particularly to an electrical connector mounted on a Printed Circuit Board (PCB).

2. Description of Related Art

With the rapid development of the electronic technology, electrical connectors are widely used in electronic products for exchanging information or data etc. with peripheral devices. An electrical connector usually comprises an insulative housing and a plurality of contacts accommodated in the insulative housing. The solder feet of corresponding contacts extend beyond a rear end of the insulative housing for being soldered to a Printed Circuit Board (PCB).

To satisfy the requirements of stable signal transmission and high transmission efficiency of the electronic products, it is required to solder the electrical connector to the PCB stably. However, it needs labor to solder the solder feet of the current electrical connector to the PCB. This process is time-consuming and labor-consuming, of course low efficiency. Meanwhile, the solder quality cannot be assured and more test and check need to be done after solder which spends more working hour.

Hence, it is necessary to improve the conventional electrical connector to address problems mentioned above.

### BRIEF SUMMARY OF THE INVENTION

Accordingly, an object of the present invention is to provide an electrical connector assembly which could realize being soldered automatically with high stability.

Another objet of the present invention is to provide an electrical connector for electrically connecting with two Printed Circuit Board (PCB).

In order to achieve the above-mentioned object, an electrical connector assembly in accordance with the present invention comprises an insulative housing, a plurality of contacts, a least a first PCB electrically connecting with the contacts, a pair of restriction sections, and a pair of fastening elements. The insulative housing comprises an upper wall, a lower wall opposite to the upper wall, and a pair of sidewalls connecting with the upper and lower walls which circumscribe a plurality of first receiving slots, a plurality of second receiving slots spaced from the first receiving slots along an up-to-down direction, and a receiving cavity located between and communicating with the first and second receiving slots. The contacts are arranged into a plurality of groups. Each group of contacts is respectively received in the first and second receiving slots. The first PCB comprises a pair of side sections partially surrounding the insulative housing. The pair of restriction sections are connected with the sidewalls of the insulative housing and partially overlap with the side sections of the first PCB. The pair of fastening elements respectively pass through the restriction sections and the side sections of the first PCB to align and position the relative position between the insulative housing and the first PCB for achieving more reliably electrical connection between the first PCB and the contacts.

In order to achieve the above-mentioned object, an electrical connector in accordance with the present invention for electrically connecting with at least a PCB comprises an insulative housing, a plurality of contacts and a pair of restriction sections. The insulative housing comprises an upper wall, a lower wall opposite to the upper wall, and a pair of sidewalls connecting with the upper and lower walls which circumscribe a plurality of first receiving slots, a plurality of second receiving slots spaced from the first receiving slots along an up-to-down direction, and a receiving cavity located between and communicating with the first and second receiving slots. The contacts are arranged into a plurality of groups with each group of contacts respectively received in the first and second receiving slots. The pair of restriction sections are respectively connected with the sidewalls of the insulative housing for positioning said at least one PCB.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical connector assembly in accordance with the present invention;

FIG. 2 is an exploded, perspective view of the electrical connector assembly in accordance with the present invention with Printed Circuit Boards (PCB) separated from an electrical connector;

FIG. 3 is an assembled, perspective view of the electrical connector in accordance with the present invention shown in FIG. 2;

FIG. 4 is an exploded, perspective view of the electrical connector shown in FIG. 3;

FIG. 5 is a perspective view of an insulative housing shown in FIG. 4;

FIG. 6 is a view similar to FIG. 5, but from a different aspect;

FIG. 7 is a perspective view of a fastening element shown in FIG. 4; and

FIG. 8 is a perspective view of a group of contact shown in FIG. 4.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

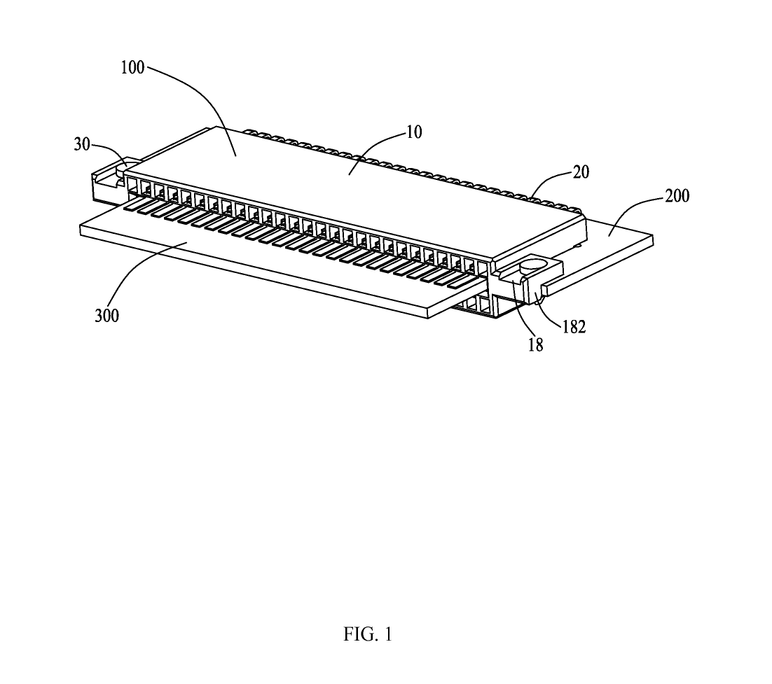

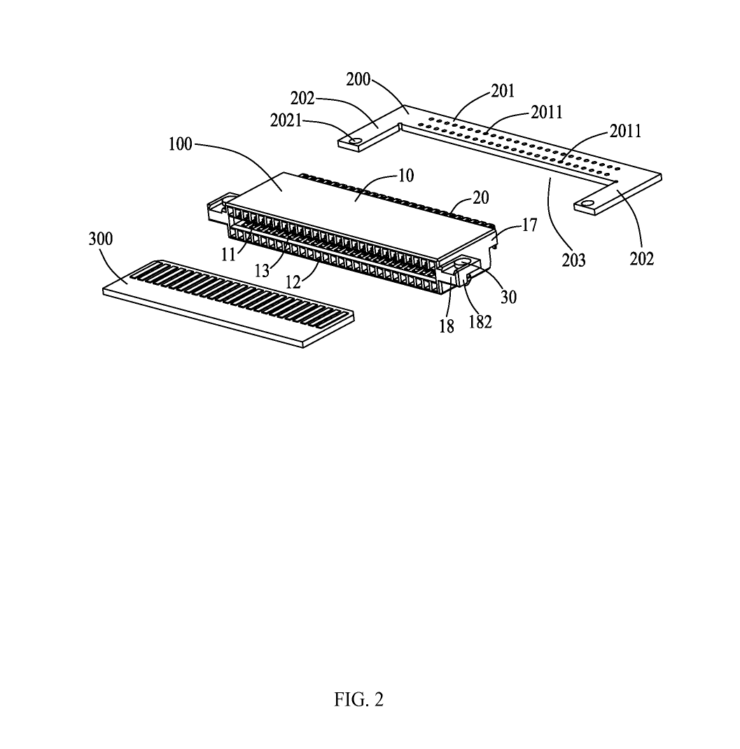

Please refer to FIGS. 1-2, an electrical connector 100 in accordance with the present invention is used to be assembled to Printed Circuit Boards (PCB) to realize electrical connection therebetween. The PCBs comprise a first PCB 200 and a second PCB 300.

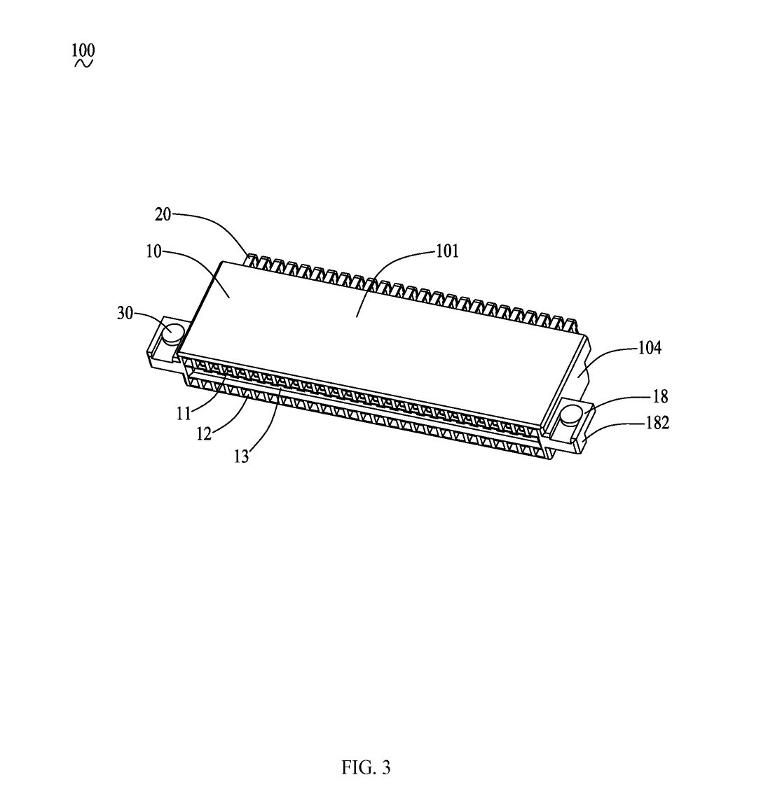

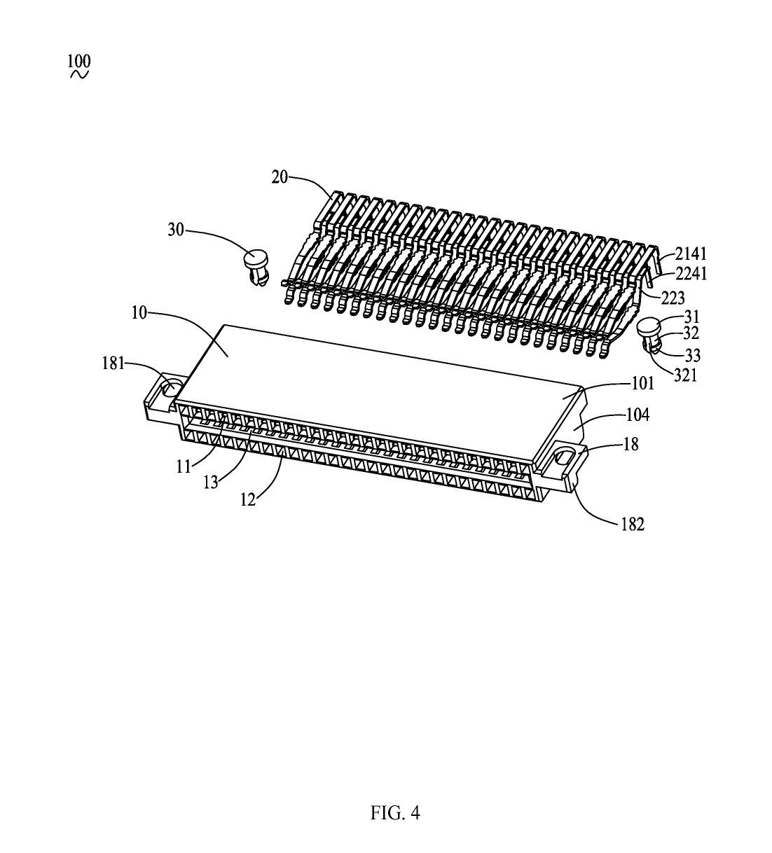

Please refer to FIGS. 3-4, the electrical connector 100 comprises an insulative housing 10 and a plurality of contacts 20 accommodated in the insulative housing 10.

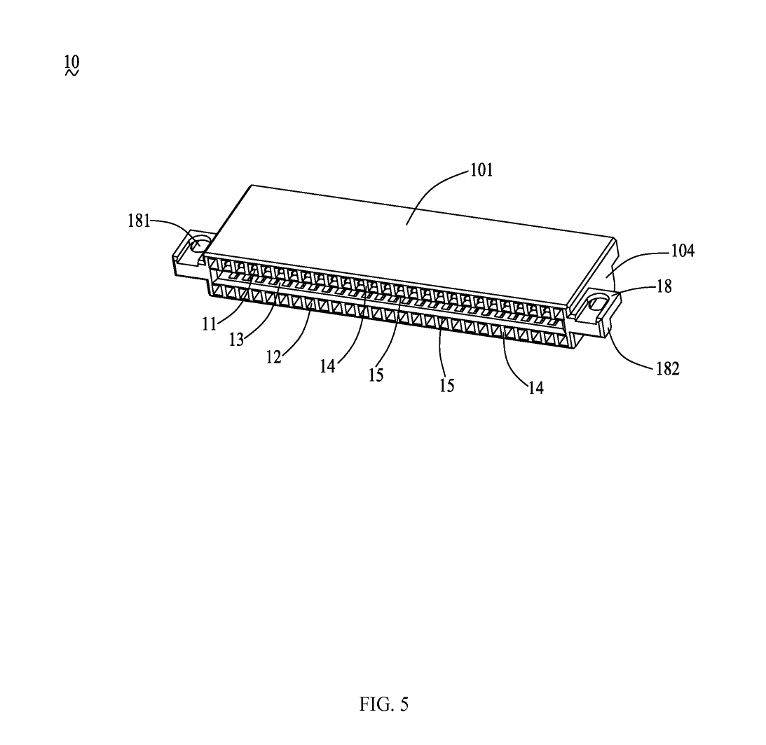

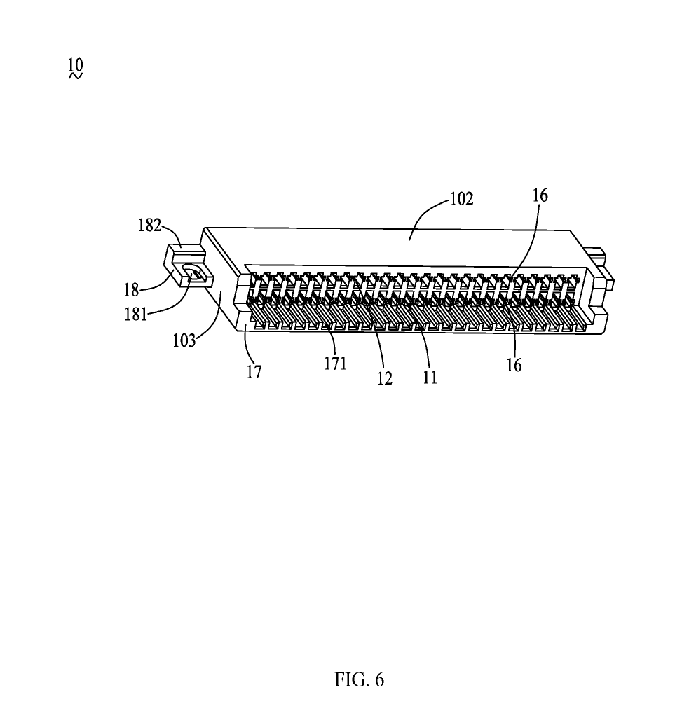

Please refer to FIGS. 5-6, the insulative housing 10 comprises an upper wall 101, a lower wall 102 opposite to the upper wall 101, and opposite left sidewall 103 and right sidewall 104 connecting with the upper wall 101 and the lower wall 102. The upper wall 101, the lower wall 102, the left sidewall 103 and the right sidewall 104 together circumscribe a plurality of first receiving slots 11, a plurality of second receiving slots 12 opposite to and spaced from the first receiving slots 11 along an up-to-down direction, and a receiving cavity 13 located between and communicating with the first and second receiving slots 11, 12.

In the preferred embodiment of the present invention, each of the first and second receiving slots 11, 12 is rectangular and penetrate through the insulative housing 10 along a front-to-back direction. Adjacent two first receiving slots 11 are divided by a first partition wall 14, and adjacent two second receiving slots 12 are divided by the first partition wall 14. The first receiving slots 11 and the receiving cavity 13 are spaced from each other by a second partition wall 15. The second receiving slots 12 and the receiving cavity 13 are spaced from each other by the other second partition wall 15.

A pair of opposite sliding slits 16 are defined in opposite inner walls of each first receiving slot 11/second receiving slot 12 and extend forwardly a certain distance from a rear surface of the insulative housing 10. A tongue-shape rear portion 17 extends rearward from the junction of the upper wall 11 and the rear surface of the insulative housing 10. The rear portion 17 is slotted with a plurality of channels 171 which are recessed upwardly from a lower surface of the rear section 17 and respectively align with and communicate with the first receiving slots 11.

Each of the left and right sidewalls 103, 104 is arranged with a restriction section 18 which is defined with a round hole 181 and near to a front surface of the insulative housing 10. The restriction section 18 forms a block section 182 in front of the round hole 181 and extending downwardly to make the restriction section 18 L-shape. In the preferred embodiment of the present invention, the restriction sections 18 protrude outwardly from the opposite left and right sidewalls 103, 104. However, in an alternative embodiment, the restriction sections 18 also could be assembled to the left and right sidewalls 103, 104.

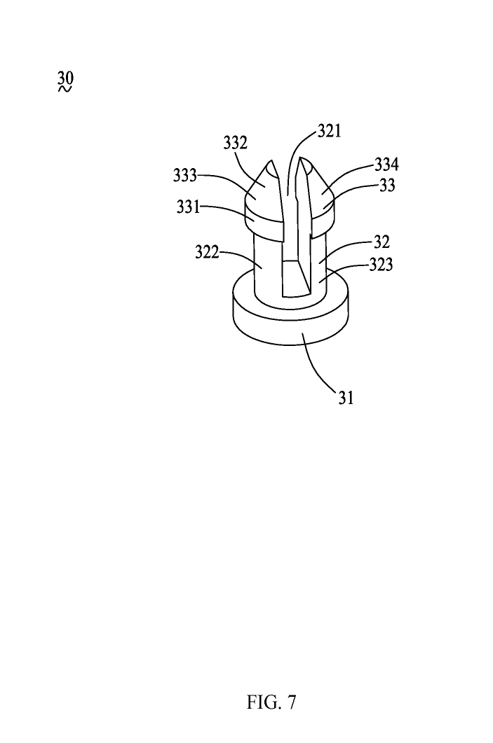

Please refer to FIG. 7 in conjunction with FIG. 6, the electrical connector 100 further comprises a pair of fastening elements 30 respectively locking with the restriction sections 18. The material of the restriction sections 18 and the fastening elements 30 could be metal or plastic. Each fastening element 30 comprises a base portion 31, a body portion 32 extending vertically from a bottom surface of the base portion 31, and a free enlarged interference portion 33 formed at a distal end of the body portion 32. The base portion 31 and the body portion 32 are of column shape, and the diameter of the body portion 32 is less than that of the base portion 31 so that the body portion 32 could pass through the hole 181 and latch with the restriction section 18.

The interference portion 33 comprises a column-shape first section 331 and a cone-shape second section 332 with the diameter of the first section 331 larger than that of the second section 332. The diameter of the second section 332 is decreased gradually and linearly.

In the preferred embodiment, the fastening element 30 further defines a slot 321 extending from a free end of the second section 332 toward the base portion 31. The slot 321 divides the body portion 32 and the interference portion 33 into opposite first and second body portions 322, 323 and opposite first and second interference portions 333, 334 spaced by the slot 321. So, the fastening element 30 is of fish spear shape. However, in an alternative embodiment, the slot 321 could be omitted.

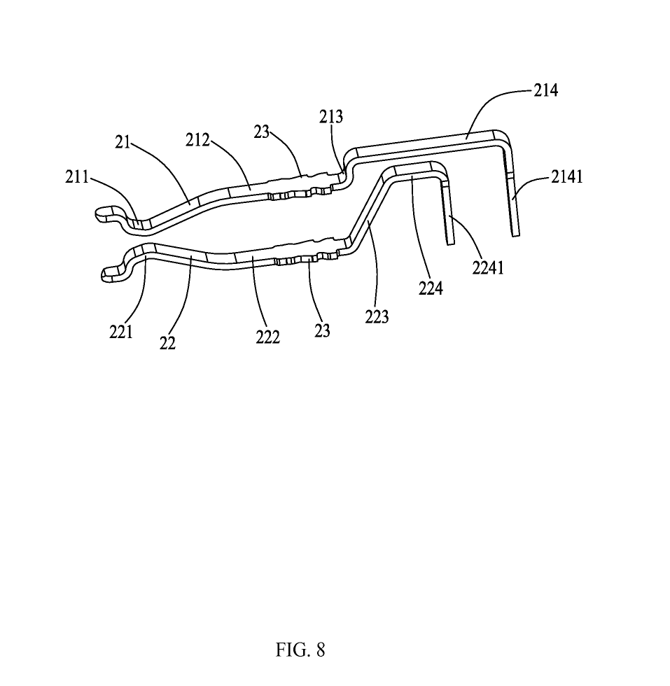

Please refer to FIG. 8 in conjunction with FIGS. 2, 4 and 6, the contacts 20 are divided into a plurality of groups. Each group of contacts 20 comprises an upper first contact 21 and a lower second contact 22 spaced from the first contact 21, respectively received in a corresponding first receiving slot 11 and a corresponding second receiving slot 12.

The first contact 21 comprises a first contacting section 211 contacting with the second PCB 300, a first termination section 214 soldered with the first PCB 200, a first intermediate section 212 extending from one end of the first contacting section 211 toward the first termination section 214, and a connecting section 213 connecting the first intermediate section 212 with the first termination section 214. The first termination section 214 is of L-shape, a horizontal section thereof extending rearward from the first connecting section 213 and a vertical section served as a first solder foot 2141 bending downward from the horizontal section for being soldered with the first PCB 200. In the preferred embodiment of the present invention, the first termination section 214 is retained and partially received in the channel 171.

The second contact 22 comprises a second contacting section 221 contacting with the second PCB 300, a second termination section 224 for being soldered with the first PCB 200, a second intermediate section 222 extending from one end of the second contacting section 221 toward the second termination section 224, and a second connecting section 223 connecting the second intermediate section 222 with the second termination section 224. The second termination section 224 is of L-shape, a horizontal section thereof extending rearward from the second connecting section 223 and a vertical section served as a second solder foot 2241 bending downward from the horizontal section for being soldered with the first PCB 200.

The first and second contacting sections 211, 221 are arranged symmetrically along the up-to-down direction and curved toward each other to be partially exposed into the receiving cavity 13 for sandwiching the second PCB 300. The first connecting section 213 is perpendicular to the first intermediate section 212 and the first termination section 214. The second connecting section 223 is inclined to make the second solder foot 2241 of the second termination section 224 longer than that of the first solder foot 2141 of the first termination section 214 for convenient solder. Thus, the first and second solder feet 2141, 2241 are arranged along the front-to-back direction.

The first and second intermediate sections 212, 222 are also arranged symmetrically along the up-to-down direction. The opposite sides of each of the first and second intermediate sections 212, 222 are formed with a plurality of barbs 23 which interfere with the sliding slits 16 reliably. Via the cooperation between the barbs 23 and the sliding slits 16, the first and second contacts 21, 22 could be retained in the first and second receiving slots 11, 12 reliably.

Please refer to FIG. 2, in conjunction with FIGS. 4 and 8, in the height direction of the insulative housing 10, the first PCB 200 is located between the first and second intermediate sections 212, 222. The first PCB 200 comprises a base plate 201 and a pair of side sections 202 extending along opposite directions perpendicular to the base plate 201 which makes the first PCB 200 U-shape and partially surround the insulative housing 10. The base plate 201 defines a plurality of first positioning holes 2011 which are arranged into two rows for the penetration of the first and second solder feet 2141, 2241.

Each side section 202 of the second PCB 200 partially overlaps with the restriction section 18 and defines a second positioning hole 2021 aligning with the hole 181 of the restriction section 18 for the fastening element 30 penetrating therethrough. The two side sections 202 forms a gap 203 therebetween which has a length longer than that of the rear portion 17 of the insulative housing 10. Before soldering the first PCB 200 with the electrical connector 100, placing the first PCB 200 along a down-to-up direction to force the solder feet 2141, 2241 of the contacts 20 passing through the first positioning holes 2011. Meanwhile, the two side sections 202 are placed below the restriction sections 18 respectively with the second positioning holes 2021 aligning with the holes 181 respectively. Finally, pressing the fastening element 30 downwardly to pass through the holes 181 and the second positioning holes 2021 respectively. Then the enlarged interference portion 33 or the first and second interference portions 333, 334 latch with the lower surface of the first PCB 200. Thus, the electrical connector assembly of the present invention could realize automatic solder. Front edges of the side sections 202 of the first PCB 200 abut against the block sections 182 to restrict the movement of the first PCB 200.

The second PCB 300 is received in the receiving cavity 13 and sandwiched by the first and second contacting sections 211, 221.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical connector assembly, comprising:
an insulative housing comprising an upper wall, a lower wall opposite to the upper wall, and a pair of sidewalls connecting with the upper and lower walls which circumscribe a plurality of first receiving slots, a plurality of second receiving slots spaced from the first receiving slots along an up-to-down direction, and a receiving cavity located between and communicating with the first and second receiving slots;
a plurality of contacts arranged into a plurality of groups, each group of contacts respectively received in the first and second receiving slots;
at least a first PCB electrically connecting with the contacts, and comprising a pair of side sections partially surrounding the insulative housing;
a pair of restriction sections connected with the sidewalls of the insulative housing and partially overlapping with the side sections of the first PCB; and
a pair of fastening elements respectively passing through the restriction sections and the side sections of the first PCB to align and position the relative position between the insulative housing and the first PCB for achieving more reliably electrical connection between the first PCB and the contacts.

2. The electrical connector assembly as claimed in claim 1, wherein each restriction section defines a hole, and each side section of the first PCB defines a positioning hole aligning with the hole in the restriction section, and wherein the fastening element passes through the hole of the restriction section and the positioning hole in the side section in turn along an up-to-down direction.

3. The electrical connector assembly as claimed in claim 1, wherein the restriction section is integrated with the side wall of the insulative housing.

4. The electrical connector assembly as claimed in claim 1, wherein the restriction section is of L-shape, a front edge of the side section of the first PCB abutting against the restriction section and partially overlapping with the restriction section.

5. The electrical connector assembly as claimed in claim 2, wherein the fastening element comprises a base portion blocked by the restriction section, a body portion received in the hole of the restriction section and the positioning hole of the side section, and an enlarged interfere portion blocked by a lower surface of the side section.

6. The electrical connector assembly as claimed in claim 1, further comprising a second PCB inserted into the receiving cavity of the insulative housing to electrically connect with the contacts further with the first PCB.

7. The electrical connector assembly as claimed in claim 6, wherein the contact comprises a contacting section contacting with the second PCB, a termination section soldered with the first PCB, an intermediate section extending from one end of the contacting section toward the termination section, and a connecting section connecting with the intermediate section and the termination section.

8. The electrical connector assembly as claimed in claim 7, wherein the contacts are grouped into a plurality of groups, and wherein each group comprises a first contact and a second contact spaced from the first contact along an up-to-down direction and respectively received in the first receiving slot and the second receiving slot, and the contacting sections and the intermediate sections of the first and second contacts are respectively symmetrically arranged.

9. The electrical connector assembly as claimed in claim 8, wherein the termination section is of L-shape, and comprises a horizontal section extending rearward from the connecting section and a vertical section served as a solder foot bending downward from the horizontal section to be soldered to the first PCB, and wherein the solder feet of the first and second contacts are arranged along a front-to-back direction.

10. An electrical connector adapted for electrically connecting with at least a PCB, comprising:
an insulative housing comprising an upper wall, a lower wall opposite to the upper wall, and a pair of sidewalls connecting with the upper and lower walls which circumscribe a plurality of first receiving slots, a plurality of second receiving slots spaced from the first receiving slots along an up-to-down direction, and a receiving cavity located between and communicating with the first and second receiving slots;
a plurality of contacts arranged into a plurality of groups, each group of contacts respectively received in the first and second receiving slots; and
a pair of restriction sections connected with the sidewalls of the insulative housing for positioning said at least one PCB.

11. The electrical connector as claimed in claim 10, wherein the restriction section is integrated with the side wall of the insulative housing.

12. The electrical connector as claimed in claim 11, wherein the restriction section is of L-shape, and forms a block section for abutting against the at least one PCB.
